(19) United States
(12) Patent Application Publication
(10) Pub. No.: US 2006/0141100 A1
(43) Pub. Date: Jun. 29, 2006

(54) Bread product and method for its production

(76) Inventors: Visarion Ivanov Dimitrov, Russe (BG); Iskren Iranov Dimitrov, Russe (BG)

Correspondence Address: John B Hardaway III;Nexsen Pruet Adams Kleemeier, P O Box 10107, Greenville, SC, 29603, US

(21) Appl. No.: 10/562,744

(22) PCT Filed: May 17, 2005
(86) PCT No.: PCT/BG04/00009

§ 371 Date: Dec. 29, 2005

(30) Foreign Application Priority Data
Jun. 30, 2003 (BG) 107955

(51) Int. Cl. A21D 13/00

(52) U.S. Cl. 426/94

(57) ABSTRACT

A bread product can be used for production of bread, round loaves, French bread, sandwiches, rusks, refreshments, pizzas. In the volume of the bread product is formed at least one section containing a product of vegetable origin added to the dough in the form of powder and/or juices and/or purees and/or natural colorants. Each section has taste and colour determined by the product of vegetable origin added to the dough and its taste and colour are different from the taste and colour of the adjacent sections.

### TECHNICAL FIELD

The invention relates to a bread product containing additives of vegetable origin, which can be used in the food processing industry for production of bread, round loaves, French bread, sandwiches, rusks, refreshments, pizzas. The invention also relates to a method for production of this bread product.

### BACKGROUND OF THE INVENTION

There are known bread products containing vegetable and fruit additives, which provide vitamins, microelements, ballast substances and other valuable components and give the bakery products a specific taste.

For example, the publication “FRESH, UNIQUE TASTE”, BAKERY PRODUCTION AND MARKETING, GORMAN PUBL., CHICAGO, Ill., US, vol. 29, No 1, p. 56, describes the application of a bread additive of sun-dried tomatoes.

DE 37 00 953 describes bread products with vegetable and fruit additives to the dough for the purpose of adding ballast substances to the grain ingredients, such as carrots, asparagus, onion, potatoes, celery, pears, plums, strawberries, etc. According to the embodiments, a homogenous dough mass is obtained where the respective additive is uniformly distributed throughout its volume.

SU 1191050 describes bread products containing a vegetable additive in the amount of 20-30%. For example, stewed and mashed carrots, dried by means of rollers to 10% moisture content. The solid residuals are grinded to particle size 80-120 μm and added to the dough.

RU 2165709 describes bread products containing powdered nettles obtained by grinding dried nettles to particle size 20-30 μm. The quantity of powdered nettles added to the dough is 0.25-3.24% of the total mass of the other ingredients, which is 0.5-6.0% of the flour mass. The bakery product is made by the following method: Dough is kneaded of flour and water, to which baking powder, powdered nettles and other ingredients of the bakery product have been added. After rising, the dough is cut, molded and baked. The powdered nettles additive enriches the bread products with amino acids, vitamins, minerals, pigments and other wholesome substances. In addition, it acts as a colorant—it gives a dark green colour to the bread products.

The known bread products containing additives of vegetable origin have uniform colour and taste throughout the volume of the product, determined by the type of additive used. The wholesome substances content in them is limited to their content in the particular additive.

### DISCLOSURE OF THE INVENTION

The object of the invention is a bread product enriched with a wide range of wholesome substances, which has higher and diverse gustatory qualities and improved aesthetic appearance.

According to the invention, in the volume of the bread product is formed at least one section containing a product of vegetable origin added to the dough in the form of powder and/or juices and/or purees and/or natural colorants. Each section has taste and colour determined by the product of vegetable origin added to the dough and its taste and colour are different from the taste and colour of the adjacent sections.

The number of coloured sections in the volume of the bread product is at least one and is determined at will depending on the kind of bread product and the desired form of coloured sections. For example, for mass production bread the optimal number of coloured sections, to which the product of vegetable origin is added, is from 1 to 20.

The product of vegetable origin includes vegetables, fruits and natural colorants.

Vegetables with colouring effect can be: spinach, carrots, tomatoes, red peppers, green peppers, nettles, dock, seaweeds, broccoli, Brussels sprouts, cauliflower, string beans, onion leafs, garlic leafs, peas, lettuce, beet, pumpkin, mushrooms, as well as spices with colouring effect such as parsley, curcuma, soya sauce, celery, mint, basil. Fruits with colouring effect can be: cherries, morello cherries, strawberries, raspberries, figs, apples, blueberries, blackberries, cornel-cherries, olives, citrus fruits such as oranges, bananas, kiwi, pineapple, grapefruit.

The quantity of the product of vegetable origin added to the dough in a given section is between 0.1 and 100% weight of the flour and is determined by the product type, the form in which it is added—powder, juice, puree or natural colorant—as well as by its content of valuable components and colour pigments ensuring a saturated colour to the respective section.

When powdered products of vegetable origin are used, the particle size is between 20 and 120 μm and is determined according to the product type so as not to have a negative effect on the dough quality.

The individual sections of the bread product may contain spices added to the dough, such as: mint, marjoram, black pepper, basil, hogweed, mustard, ginger, taros, sweet pepper, cayenne, savory, dill, celery, parsley, curry. The spice is selected to be compatible in taste with the product of vegetable origin added to the dough in the given section. For example, parsley is a suitable spice for tomatoes, marjoram for spinach, savory for nettles, dill for string beans.

The individual sections of the bread product may contain food products added to the dough, such as powdered dried meat, fish, nuts, cheese. These food products are chosen so as to be compatible in taste with the product of vegetable origin added to the dough in the respective section. For example, fish for the seaweed section, cheese for the tomato section, veal for the spinach section, pineapple for the chicken section.

The above mentioned products of vegetable origin and food products do not restrict the invention.

The form of the coloured sections is chosen at will and depending on the bread product shape. In horizontal or vertical cross-section (depending on the bread product shape), the form of the coloured sections may be an irregular polygon, triangle, circle, ellipse, heart, flower, clover, a letter, inscription, emblem, logo. A combination of different forms in one bakery product is possible. When the bread is cut in slices, each slice has a clearly outlined section or plurality of sections of particular form or combination of forms. The mentioned forms of the coloured sections do not restrict the invention.

The multicolored bread product according to the invention may be of the type of traditional bread, round loaves, French bread, sandwiches, rusks, refreshments, pizzas produced of any kind of flour (ground, crushed, wholegrain)—wheat, rye, barley, soya and mixtures thereof. The multicolored bread product can also be used in the production of graham bread, dietary bread, bakery products with curative-prophylactic properties, etc.

The method for production of the multicolored bread product according to the invention is the following: As many kinds of dough are kneaded simultaneously as are the coloured sections. If the bread product has a section without additives of vegetable origin, a traditional dough is also kneaded along with the others. If the products of vegetable origin are powdered or in the form of purees, they are added in the required quantity to the water for kneading the dough. If the products are in the form of juices, the dough is kneaded with them, diluting the juices with water if required. If the dough is kneaded with yeast, the rising time is the same for all doughs. Depending on the desired form of the coloured sections, the different kinds of dough are put together by mechanical pasting; pasting and twisting or weaving; simultaneous extruding by means of an extruder with a nozzle in the desired shape. Depending on the way the different doughs are combined, this operation can be done before or after the dough has risen. Then the bread product is cut and baked. In the operations devices and equipment known to person skilled in the art can be used.

The simultaneous kneading, rising and putting together of the many doughs which form the bread product is conducive to uniform baking of the different sections and prevents the falling apart of the bread product at the section borders when it is cut or broken.

The products of vegetable origin are dried by known methods: freeze drying; drying in drying chambers; air drying; sun drying; drying in a revolving drum; hot air drying, etc. The method of drying is selected so as to preserve the valuable components of the respective product. The powdering of the dried products to particle size as specified above is done by grinding, rolling and other methods known to person skilled in the art.

With the use of some products of vegetable origin the colour of the bread product sections, where these products are added, does not correspond to the colour of the fresh product because the colour of the pigments contained in the product changes during the drying of the product or in the process of baking the bread product. For example, fresh carrots are yellowish-orange, whereas the carrot sections are white as a result of the baking of the bread product.

The multicolored bread products have high gustatory qualities, each section having colour and taste determined by the added product of vegetable origin, which can meet the most refined taste of consumers. The variegation and combination of different aromas make the bread products according to the invention attractive and particularly suitable for children and people who have no appetite. In making bread products with curative-prophylactic properties the products of vegetable origin can be so selected and combined as to provide the required for a given purpose quantities of proteins; carbohydrates; amino acids; ballast substances; vitamins A, B₁, B₂, B₃, B₆, B₁₂, D, E, K, P, PP, E, F; microelements such as sodium, potassium, calcium, magnesium, phosphor, iron, manganese, copper; and other valuable components. The adding of a combination of products of vegetable origin leads to increased biological value of the bakery products without impairing their taste.

### BRIEF DESCRIPTION OF THE FIGURE

FIG. 1 is a view of a bread product according to one embodiment of the invention.

### BEST MODE OF CARRYING OUT OF THE INVENTION

The invention is illustrated by the following examples, which do not restrict it.

### EXAMPLE 1

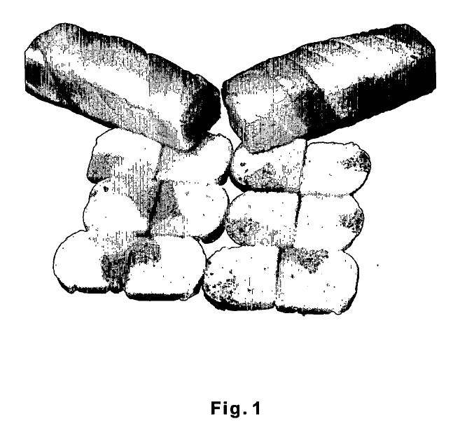

Five kinds of dough are kneaded separately and simultaneously by the following technology: In five kneaders leaven is prepared of flour and yeast which has been preliminarily dissolved in water. The obtained dough is left to rest for 2-2.5 hours, then the required quantities of salt, flour and water are successively added, where vegetables have been preliminarily added to the water as follows: for the first kind of dough—powdered nettles in the amount of 30% weight of the flour used and particle size 30 μm; for the second kind of dough—tomato juice in the amount of 40% weight of the flour used; for the third kind of dough—powdered spinach in the amount of 20% weight of the flour and particle size 40 μm; for the fourth kind of dough—powdered red peppers in the amount of 10% weight of the flour used and particle size 20 μm; for the fifth kind of dough—mashed carrots in the amount of 30% weight of the quantity of flour. The doughs are kneaded again and left for about 40 minutes to slacken. After the simultaneous preparation of the doughs they are put together mechanically, without mixing, and twisted, then they are cut, molded, baked and packed. A general view of the obtained multicolored bread and of individual slices is shown in FIG. 1. When the bread is cut there is a combination of five sections in the form of an irregular polygon, tinted in the following colors: the nettles section in dark green; the tomato section in brown; the spinach section in light green; the red peppers section in red; and the carrots sections in white. When a slice of this bread is eaten each section has a specific pleasant taste and aroma, and at the same time the combination of the added vegetables provides a wide range of substances valuable for the human body.

### EXAMPLE 2

A bread product is prepared as in Example 1, but to the tomato juice is added powdered cheese in the amount of 20% weight of the juice, and to the spinach—dried and finely ground veal in the amount of 10% weight of the spinach. The obtained multicolored bread has higher protein content.

### EXAMPLE 3

Seven kinds of dough are prepared simultaneously by the technology described in Example 1, with the following difference: in the individual doughs powdered seaweeds are added of different colour—green, brown, yellow, blue, black, orange and lilac. The quantity of seaweeds in each kind of dough is 20% weight of the flour and the particle size is 50 μm. The rest of the operations are the same as in Example 1. The obtained multicolored bread has an attractive appearance and is rich in iodine and microelements.

### EXAMPLE 4

Five kinds of dough are prepared simultaneously by the technology described in Example 1, with the following difference: to the water with which the dough is kneaded citrus juices are added in the following quantities (in % weight of the flour): pineapple—40, orange—20, kiwi—30, banana—20, grapefruit—20. The rest of the operations are the same as in Example 1. The obtained multicolored bread consists of sections in pale yellow, orange, green, yellow and red colour and is rich in vitamins, enzymes and minerals.

### EXAMPLE 5

A bread product is prepared as in Example 4, with the following difference: instead of orange juice, natural colorant of orange is added to the water for kneading the second dough in the amount of 0.8% weight of the flour in this section. The rest of the operations are the same as in Example 4.

### EXAMPLE 6

The procedure is as in Example 4, with the following difference: to the water for kneading the pineapple dough dried and finely ground chicken is added in the amount of 5% weight of the flour. The obtained multicolored bakery product has higher protein content.

### EXAMPLE 7

Two kinds of dough are simultaneously prepared, where one kind is kneaded with water without vegetable additives, and to the water for kneading the other kind of dough powdered nettles is added in the amount of 50% weight of the flour used in this dough and particle size 30 μm. Before they rise, the two kinds of dough are combined in an extruder supplied with a nozzle, in the centre of which there is a clover form. For extrusion the nettles dough is placed in the middle, surrounded by the traditional dough. The rest of the operations are the same as in Example 1. A slice of this bread has a green section in the centre in the form of a clover and the rest is of colour characteristic for the type of flour used.

1-11. (canceled)

12. A bread product, characterized in that in the volume of the bread product is formed sections comprising different vegetables or fruits containing colouring pigments and said vegetables or fruits are in the form of powders, purees and/or natural colorants added to the dough, whereby each section has taste and colour determined by the vegetable or fruit added to the dough and the taste and colour of each section is different from the taste and colour of the adjacent sections.

13. A bread product according to claim 12, characterized in that the number of coloured sections in the volume of the bread product is from 1-20.

14. A bread product according to claim 12, characterized in that the vegetables with colouring effect are: spinach, carrots, tomatoes, red peppers, green peppers, nettles, dock, seaweeds, broccoli, Brussels sprouts, cauliflower, string beans, onion leafs, garlic leafs, peas, lettuce, beet, pumpkin and mushrooms, as well as spices with colouring effect such as parsley, curcuma, soya sauce, celery, mint and basil.

15. A bread product according to claim 12, characterized in that the fruits with colouring effect are: cherries, morello cherries, strawberries, raspberries, figs, apples, blueberries, blackberries, cornel-cherries, olives, citrus fruits such as oranges, bananas, kiwi, pineapple and grapefruit.

16. A bread product according to claim 12, characterized in that the content of the vegetable or fruit added to the dough of a given section is between 0.1 and 100% by weight of the flour used in this particular section.

17. A bread product according to claim 12, characterized in that the vegetables or fruits are powders of particle size from 20 to 120 μm.

18. A bread product according to claim 12, characterized in that the different sections of the bread product further contain spices added to the dough, such as mint, marjoram, black pepper, basil, hogweed, mustard, ginger, taros, sweet pepper, cayenne, savory, dill, celery, parsley and curry.

19. A bread product according to claim 12, characterized in that the different sections of the bakery product further contain additional powdered food products added to the dough, such as meat, fish, nuts and cheese.

20. A bread product according to claim 12, characterized in that the form of the coloured sections in horizontal or vertical cross-section of the bakery product can be an irregular polygon, triangle, circle, ellipse, heart, flower, clover, a letter, inscription, emblem, logo, as well as a combination of these.
